(19) United States
(12) Patent Application Publication
(10) Pub. No.: US 2025/0253081 A1
(43) Pub. Date: Aug. 7, 2025

(54) MULTI-CORE SEGMENT VARIABLE INDUCTOR WITH DIFFERENT CORE MATERIALS, AND CONTROL CIRCUIT AND CONTROL METHOD THEREOF

(71) Applicant: GUANGDONG UNIVERSITY OF TECHNOLOGY, GUANGZHOU (CN)

(72) Inventors: GUIDONG ZHANG, GUANGZHOU (CN); ZIJIE HE, GUANGZHOU (CN); MAOQUAN LIU, GUANGZHOU (CN); YUN ZHANG, GUANGZHOU (CN)

(21) Appl. No.: 18/780,891

(22) Filed: Jul. 23, 2024

(30) Foreign Application Priority Data
Feb. 2, 2024 (CN) 202410151680.0

(51) Int. Cl. H01F 3/14; H01F 27/00; H01F 27/42; H01F 29/00

(52) U.S. Cl. CPC H01F 3/14; H01F 27/006; H01F 27/42; H01F 29/00

(57) ABSTRACT

A multi-core segment variable inductor with different core materials, and a control circuit and a control method thereof. The variable inductor includes a center magnetic segment c, wherein a winding on the center magnetic segment c serves as an inductive winding, and a number of turns of the center magnetic segment is N_{ac}; and peripheral magnetic segments, wherein a number of the peripheral magnetic segments is n; the peripheral magnetic segments are labeled as p₁, p₂, p₃, . . . , to pₙ; a winding on each peripheral magnetic segment serves as a control winding, and the control windings on the peripheral magnetic segments are configured to independently operate; a number of turns of the control winding of each peripheral magnetic segment is correspondingly N_{dc_p1}, N_{dc_p2}, N_{dc_p3}, . . . , N_{dc_pn}; wherein an air gap exists between each peripheral magnetic segment and the center magnetic segment, and a length of the air gap is l_{g}.

### CROSS REFERENCE

The present disclosure claims priority of Chinese Patent Application No. 202410151680.0, filed on Feb. 2, 2024, the entire contents of which are hereby incorporated by reference in their entirety.

### TECHNICAL FIELD

The present disclosure relates to the technical field of electromagnetic control, and more specifically to a multi-core segment variable inductor with different core materials, and a control circuit and a control method thereof.

### BACKGROUND

Variable inductors, as an important power electronic device, have been widely applied in lighting equipment drive, wireless energy transmission, battery charging and discharging, electric vehicles, and other fields. Existing variable inductors are mainly realized in three ways: (1) Quasi-linear variable inductors with the same core material, where the permeability of the inductors is controlled into a nonlinear region to achieve continuous changes in the inductance value; however, due to the fact that the control winding and the inductance winding cannot be completely decoupled from each other, the quasi-linear variable inductors are difficult to control and cannot achieve a stable and precise change in the inductance value. (2) Swing inductors with the same core material, where the air gap of the magnetic core (hereafter “core”) is changed to realize a segmented saturation of the inductor to achieve changes in the inductance value; however, due to structural constraints, the inductance value's range is difficult to expand; further, the swing inductors are mainly passive inductors, such that the swing inductors are unable to actively change the inductance value. (3) Superposition inductors with different core materials, having different core materials, where the different core materials are gradually saturated to achieve changes in the inductance value; however, due to the need for sintering, the superposition inductors have high difficulty in preparation and high cost of production; further, the superposition inductors are mainly passive inductors, such that the superposition inductors are unable to actively change the inductance value. The variable inductor is required to be applied to some occasions with high control precision and large inductance adjustment range, so as to be easily adjusted and designed, whereas the existing variable inductors are generally difficult to be applied to these occasions due to the above deficiencies.

Therefore, how to provide a technical solution to the above technical problems is urgently required to be solved by those skilled in the art.

### SUMMARY OF THE DISCLOSURE

The present disclosure discloses a multi-core segment variable inductor with different core materials, and a control circuit and a control method thereof. Two types of core materials are adopted: (1) Strong direct current (DC) bias resistance; due to the setting of the air gap, the control winding on each peripheral magnetic segment generates magnetic mainly passing through the center magnetic segment; the core material with a strong DC bias resistance is selected as the center magnetic segment, so as to avoid the center segment from entering a saturated state. (2) Poor DC bias resistance; since the main operation mode of this inductor is to control the magnetic saturation state of the peripheral magnetic segments, a core material with poor DC bias resistance is selected as the peripheral magnetic segments of this inductor, so as to ensure that the peripheral magnetic segments can easily enter the saturation state. The magnetic saturation degree of the peripheral magnetic segments is changed by changing the size of the current in the control winding, and a suitable core material is selected as the center magnetic segment to ensure that the peripheral magnetic segment is saturated while the center magnetic segment operates in a non-saturated state. Compared to the variable inductor in the related art, the multi-core segment variable inductor with different core materials enables the control of variable inductance value with high accuracy and stability, high scalability, and simple production of the variable inductor structure. Further, a control circuit and control method for the multi-core segment variable inductor with different core materials are disclosed, which expands the application fields of the variable inductor.

Specifically, the present disclosure proposes the following technical solutions.

A multi-core segment variable inductor with different core materials, including: n peripheral magnetic segments, viewed clockwise as p₁, p₂, p₃, . . . , to pₙ; a center magnetic segment c; an air gap between two ends of each peripheral magnetic segment and the center magnetic segment; n independent control windings on the n peripheral magnetic segments, clockwise viewed as a first control winding, a second control winding, a third control winding, . . . , to an nth control winding; and an inductive winding on the center magnetic segment; where the core materials of the center magnetic segment and the individual peripheral magnetic segments are variable according to specific requirements of the inductor.

The specific composition structure is as follows:
The winding of the peripheral magnetic segment p₁ is the first control winding, and the number of turns of the first control winding is N_{dc_p1};
The winding of the peripheral magnetic segment p₂ is the second control winding, and the number of turns of the second control winding is N_{dc_p2};
The winding of the peripheral magnetic segment p₃ is the third control winding, and the number of turns of the third control winding is N_{dc_p3};
The winding of the peripheral magnetic segment pₙ is the nth control winding, and the number of turns of the nth control winding is N_{dc_pn};
The winding of the center magnetic segment c is the inductive winding, and the number of turns of the inductive winding is N_{ac};
The air gap l_{g} is opened between the two ends of each peripheral magnetic segment and the center magnetic segment.

A control circuit of the multi-core segment variable inductor with different core materials, including:
a microcontroller, a current control circuit 1, a current control circuit 2, a current control circuit 3, . . . , to a current control circuit n, a detection circuit 1, a detection circuit 2, and a detection circuit 3, . . . , to a detection circuit n.

A control principle of the multi-core segment variable inductor with different core materials, including:
Step 1: the microcontroller calls a control program;
Step 2: each of the n detection circuits collects the current on the control winding on a corresponding peripheral magnetic segment, and transmits the current to the microcontroller;
Step 3: the microcontroller controls the current control circuit corresponding to the peripheral magnetic segment pₓ that is required to be saturated to output a corresponding current;
Step 4: the current control circuit outputs the current, causing the peripheral magnetic segment pₓ to enter a saturation state.

Combined with the schematic diagram of the equivalent magnetoresistance circuit, the total peripheral magnetoresistance formula for the multi-core segment variable inductor with different core materials is as follows:

$${R}_{p}^{t o t} = [ {R}_{p 1} ( {μ}_{p 1} ) + {R}_{g} ] ⊓ … ⊓ [ {R}_{p n} ( {μ}_{p n} ) + {R}_{g} ]$$

where Rₚ^{tot} is the total peripheral magnetoresistance, Rₚ₁ is the magnetoresistance of the peripheral magnetic segment p₁, Rₚₙ is the magnetoresistance of the peripheral magnetic segment pₙ, R_{g} is the air-gap magnetoresistance, μₚ₁ is the magnetic permeability of the peripheral magnetic segment p₁, and μₚₙ is the magnetic permeability of the peripheral magnetic segment pₙ.

According to the formula for calculating the inductance, an equivalent inductance formula for the multi-core segment variable inductor with different core materials can be obtained:

$${L}_{e q} = \frac{{N}_{a c}^{2}}{{R}_{c} ( {μ}_{c} ) + {R}_{p}^{tot}}$$

wherein, L_{eq} is the equivalent inductance value of the variable inductor, R_{c} is the magnetoresistance of the center magnetic segment, Rₚ^{tot} is the total peripheral magnetoresistance, and N_{ac} is the number of turns of the inductive winding on the center magnetic segment.

As can be seen from the above technical approach, the implementation of the present disclosure has the following beneficial effects:

The present disclosure discloses a multi-core segment variable inductor with different core materials, and a control circuit and a control method thereof. The magnetic saturation degree of the peripheral magnetic segments is changed by changing the size of the current in the control winding, and a suitable core material is selected as the center magnetic segment to ensure that the peripheral magnetic segment is saturated while the center magnetic segment operates in a non-saturated state. Compared to the variable inductor in the related art, the multi-core segment variable inductor with different core materials enables the control of variable inductance value with high accuracy and stability, high scalability, and simple production of the variable inductor structure. Further, a control circuit and control method for the multi-core segment variable inductor with different core materials are disclosed, which expands the application fields of the variable inductor.

### BRIEF DESCRIPTION OF THE DRAWINGS

In order to make the objects, technical solutions, and advantages of the embodiments of the present disclosure clearer, the technical solutions in the embodiments of the present disclosure will be described clearly and completely in the following in conjunction with the accompanying drawings in the embodiments of the present disclosure, and it is clear that the embodiments described are some of the embodiments of the present disclosure, and not all of the embodiments. For those skilled in the art, other accompanying drawings may be obtained from these accompanying drawings without creative labor.

FIG. 1 is a schematic diagram of a multi-core segment variable inductor with different core materials, and a control circuit thereof according to the present disclosure.

FIG. 2 is a schematic diagram of an equivalent magnetoresistance circuit of a multi-core segment variable inductor with different core materials according to the present disclosure.

FIG. 3 is a schematic diagram of core magnetization curves.

### DETAILED DESCRIPTION

In order to make the objects, technical solutions and features in the embodiments of the present disclosure clearer, the technical solutions in the embodiments of the present disclosure will be described clearly and completely in the following in conjunction with the accompanying drawings in the embodiments of the present disclosure, and it is obvious that the described embodiments are only some of the embodiments of the present disclosure and not all of the embodiments. Based on the embodiments in the present disclosure, all other embodiments obtained by those skilled in the art without making creative labor fall within the scope of the present disclosure.

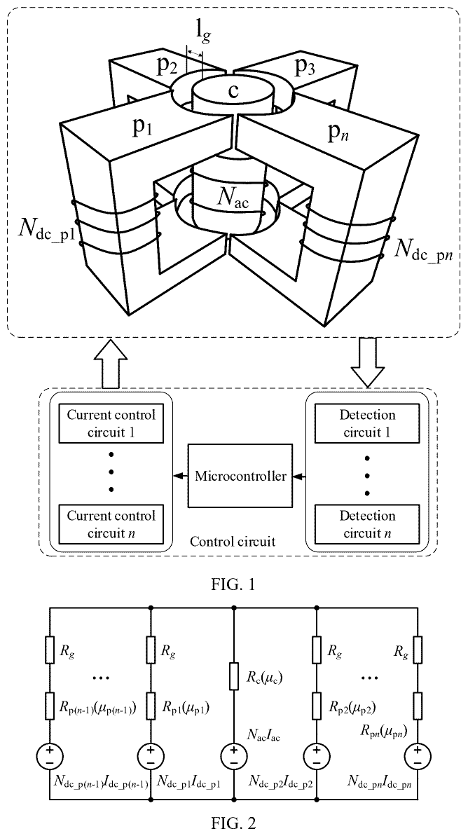

Referring to FIG. 1, FIG. 1 is a schematic diagram of a multi-core segment variable inductor with different core materials, and a control circuit thereof according to the present disclosure. The structure of the multi-core segment variable inductor with different core materials includes n peripheral magnetic segments, viewed clockwise as p₁, p₂, p₃, . . . , to pₙ; a center magnetic segment c; an air gap between two ends of each peripheral magnetic segment and the center magnetic segment; n independent control windings on the n peripheral magnetic segments, clockwise viewed as a first control winding, a second control winding, a third control winding, . . . , to an nth control winding; and an inductive winding on the center magnetic segment; where the core materials of the center magnetic segment and the individual peripheral magnetic segments are variable according to specific requirements of the inductor. The specific composition structure is as follows:
The winding of the peripheral magnetic segment p₁ is the first control winding, and the number of turns of the first control winding is N_{dc_p1};
The winding of the peripheral magnetic segment p₂ is the second control winding, and the number of turns of the second control winding is N_{dc_p2};
The winding of the peripheral magnetic segment p₃ is the third control winding, and the number of turns of the third control winding is N_{dc_p3};
The winding of the peripheral magnetic segment pₙ is the nth control winding, and the number of turns of the nth control winding is N_{dc_pn};
The winding of the center magnetic segment c is the inductive winding, and the number of turns of the inductive winding is N_{ac};
The air gap l_{g} is opened between the two ends of each peripheral magnetic segment and the center magnetic segment.

A control circuit of the multi-core segment variable inductor with different core materials, includes:
a microcontroller, a current control circuit 1, a current control circuit 2, a current control circuit 3, . . . , to a current control circuit n, a detection circuit 1, a detection circuit 2, and a detection circuit 3, . . . , to a detection circuit n.

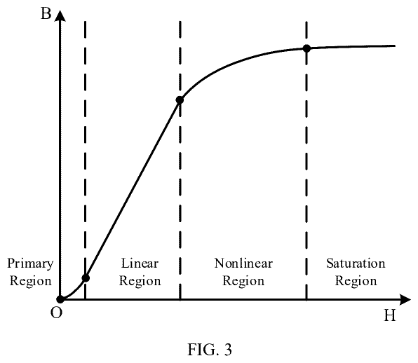

Referring to FIG. 2, FIG. 2 is a schematic diagram of an equivalent magnetoresistance circuit of a multi-core segment variable inductor with different core materials according to the present disclosure. The working principle of the inductance change of the variable inductor is analyzed in conjunction with the magnetization curve of the magnetic core of FIG. 3:
Step 1: the microcontroller calls a control program;
Step 2: each of the n detection circuits collects the current on the control winding on a corresponding peripheral magnetic segment, and transmits the current to the microcontroller;
Step 3: the microcontroller controls the current control circuit corresponding to the peripheral magnetic segment pₓ that is required to be saturated to output a corresponding current;
Step 4: the current control circuit outputs the current, causing the peripheral magnetic segment pₓ to enter a saturation state.

According to the formula for calculating the inductance:

$$L = \frac{{N}^{2} A μ}{l} = \frac{{N}^{2}}{R}$$

where L is the inductance value, μ is the magnetic permeability, A is the cross-sectional area of the magnetic core, 1 is the magnetic circuit length, and R is the magnetoresistance.

Combined with the schematic diagram of the equivalent magnetoresistance circuit, the total peripheral magnetoresistance formula for the multi-core segment variable inductor with different core materials is as follows:

$${R}_{p}^{t o t} = [ {R}_{p 1} ( {μ}_{p 1} ) + {R}_{g} ] □ … □ [ {R}_{p n} ( {μ}_{p n} ) + {R}_{g} ]$$

where Rₚ^{tot} is the total peripheral magnetoresistance, Rₚ₁ is the magnetoresistance of the peripheral magnetic segment p₁, Rₚₙ is the magnetoresistance of the peripheral magnetic segment pₙ, R_{g} is the air-gap magnetoresistance, μₚ₁ is the magnetic permeability of the peripheral magnetic segment p₁, and μₚₙ is the magnetic permeability of the peripheral magnetic segment pₙ.

According to the formula for calculating the inductance, an equivalent inductance formula for the multi-core segment variable inductor with different core materials can be obtained:

$${L}_{e q} = \frac{{N}_{a c}^{2}}{{R}_{c} ( {μ}_{c} ) + {R}_{p}^{tot}}$$

wherein, L_{eq} is the equivalent inductance value of the variable inductor, R_{c} is the magnetoresistance of the center magnetic segment, Rₚ^{tot} is the total peripheral magnetoresistance, and N_{ac} is the number of turns of the inductive winding on the center magnetic segment.

When the peripheral magnetic segment pₓ enters the saturation state, the magnetic permeability of the peripheral magnetic segment pₓ μₚₓ→0, so the magnetoresistance of the peripheral magnetic segment pₓ Rₚₓ→∞. According to the formula for the total peripheral magnetoresistance, in this case, all the magnetoresistance of the branch where the peripheral magnetic segment pₓ is located cannot have an effect on the total peripheral magnetoresistance, which is equivalent to that the branch where the peripheral magnetic segment pₓ of the equivalent magnetoresistance circuit is located is disconnected.

The present disclosure discloses a multi-core segment variable inductor with different core materials, and a control circuit and a control method thereof. Existing variable inductors are unable to take into account both control accuracy and a wide inductance variation range. As a comparison, the present disclosure proposes a multi-core segment variable inductor with different core materials, including: a center magnetic segment, multiple peripheral magnetic segments, and independent windings on the magnetic segments. The winding on the center magnetic segment is directly connected to the circuit as an inductive winding, and the winding on each peripheral magnetic segment serves as a control winding to control the inductance value variation. The inductance value depends on the number of the peripheral magnetic segments with different core materials. The degree of magnetic saturation of a certain peripheral magnetic segment is changed by changing the size of the current in the corresponding control winding, and a suitable core material is selected as the center magnetic segment to ensure that the peripheral magnetic segment is saturated while the center magnetic segment is operating in a non-saturated state. Further, a control circuit and control method for the multi-core segment variable inductor with different core materials are disclosed.

In the description of the present disclosure, it needs to be clarified that the terms “center”, “up”, “down”, “left” “right”, “vertical”, “horizontal”, “inside”, “outside”, etc. are based on those shown in the accompanying drawings and are intended only for the convenience of describing the present disclosure and for simplifying the description, but are not intended to indicate or imply that the components or modules referred to must be constructed and operated with a particular orientation, and therefore are not to be construed as limitations of the present disclosure. Furthermore, the terms “first”, “second”, “third” are intended for descriptive purposes only and are not to be understood as implying or indicating relative importance.

Unless otherwise expressly provided and limited, the terms “connection” and “mounting” are to be understood in a broad sense, e.g., as a fixed connection, a detachable connection, or a connection in one piece; a mechanical connection or an electrical connection; a direct connection or a connection through an intermediary medium; a connectivity within two elements. For those skilled in the art, the specific meanings of the above terms in the present disclosure may be understood on a case-by-case basis.

The above embodiments are only intended to illustrate the technical solutions of the present disclosure, not to limit them; the description of the embodiments of the present disclosure enables those skilled in the art to use or realize the present disclosure, and he or she can still make modifications to the technical solutions documented in the foregoing embodiments or make equivalent replacements of some of the technical features therein. Such replacements or modifications do not take the essence of the corresponding technical solutions away from the spirit of the technical solutions of the embodiments of the present disclosure.

What is claimed is:

1. A multi-core segment variable inductor with different core materials, comprising:
a center magnetic segment c, disposed at a center of the variable inductor; wherein a winding on the center magnetic segment c serves as an inductive winding, and a number of turns of the center magnetic segment is N_{ac}; and
a plurality of peripheral magnetic segments, disposed on a periphery of the variable inductor; wherein a number of the plurality of peripheral magnetic segments is n, n being a positive integer; the plurality of peripheral magnetic segments are labeled as p₁, p₂, p₃, . . . , to pₙ; a winding on each of the plurality of peripheral magnetic segments serves as a control winding, and the control windings on the plurality of peripheral magnetic segments are configured to independently operate; a number of turns of the control winding of each of the plurality of peripheral magnetic segments is correspondingly N_{dc_p1}, N_{dc_p2}, N_{dc_p3}, . . . , N_{dc_pn};
wherein an air gap exists between both ends of each of the plurality of peripheral magnetic segments and the center magnetic segment, and a length of the air gap is l_{g}.

2. A control circuit of the variable inductor according to claim 1, comprising: n current control circuits, n detection circuits, and a microcontroller;
wherein each of the n current control circuits is connected to the control winding of a corresponding peripheral magnetic segment; each of the n current control circuits is configured to independently control a size of a current passing through the control winding of a corresponding peripheral magnetic segment;
wherein each of the n detection circuits is configured to independently detect the current passing through the control winding of a corresponding peripheral magnetic segment;
wherein the microcontroller is configured to receive data collected by each of the n detection circuits and control the size of the current output by each of the n current control circuits.

3. A control method applied to the control circuit according to claim 2, comprising:
Step 1: calling, by the microcontroller, a control program;
Step 2: collecting, by each of the n detection circuits, the current on the control winding of a corresponding peripheral magnetic segment, and transmitting the current to the microcontroller;
Step 3: controlling, by the microcontroller, one of the n current control circuits corresponding to one of the plurality of peripheral magnetic segments that is required to be saturated to output a corresponding current; and
Step 4: outputting, by the one of the plurality of peripheral magnetic segments, the corresponding current, for causing the one of the plurality of peripheral magnetic segments to enter a saturation state.

4. A method for calculating a number of inductance values that is obtainable by the variable inductor according to claim 1, comprising:
$${N}_{ind}^{( n )} = {\sum }_{m = 0}^{n} C ( n , m ) = {\sum }_{m = 0}^{n} \frac{n !}{m ! ( n - m ) !}$$
wherein N_{ind}⁽ⁿ⁾ is the number of inductance values that is obtainable by the variable inductor.

5. A method for calculating an equivalent inductance value of the variable inductor according to claim 1, comprising:
$${L}_{eq} = \frac{{N}_{a c}^{2}}{{R}_{c} ( {μ}_{c} ) + \{ [ {R}_{p 1} ( {μ}_{p 1} ) + {R}_{g} ] □ … □ [ {R}_{p n} ( {μ}_{p n} ) + {R}_{g} ] \}}$$
wherein L_{eq} is the equivalent inductance value of the variable inductor; Rₚ₁ is a magnetoresistance of the peripheral magnetic segment p₁, Rₚₙ is a magnetoresistance of the peripheral magnetic segment pₙ, R_{c} is a magnetoresistance of the center magnetic segment, and R_{g} is an air-gap magnetoresistance; μₚ₁ is a magnetic permeability of the peripheral magnetic segment p₁, μₚₙ is a magnetic permeability of the peripheral magnetic segment pₙ, μ_{c} is a magnetic permeability of the center magnetic segment.
